(19) United States
(12) Patent Application Publication
(10) Pub. No.: US 2002/0161625 A1
(43) Pub. Date: Oct. 31, 2002

(54) Online media planning system

(75) Inventors: Leonardo Brito-Valladares, Ann Arbor, MI (US); Christine Gambino, Westland, MI (US); Chris Kaul, Oxford, MI (US)

Correspondence Address: McDERMOTT, WILL & EMERY, 600 13th Street, N.W., Washington, DC, 20005-3096, US

(73) Assignee: Valassis Communications, Inc.

(21) Appl. No.: 10/075,308

(22) Filed: Feb. 15, 2002

Related U.S. Application Data
(60) Provisional application No. 60/270,624, filed on Feb. 23, 2001.

(51) Int. Cl. G06F 17/60

(52) U.S. Cl. 705/10

(57) ABSTRACT

An automated system generates targeted pricing information for a marketing campaign. The system includes a server for communicating with a client system including a computer processor and associated memory. The server is part of a marketing system including a computer processor and associated memory. A database provides pricing information for the delivery of advertising materials in a plurality of printed media outlets. Each of the plurality of printed media outlets satisfies at least one of a plurality of predetermined marketing parameters. The client system and marketing system are connectable to each other via a communications network. The marketing system receives a targeted pricing information request from the client system over the communications network, the targeted pricing information request including at least one of the plurality of predetermined marketing parameters. The marketing system further includes a targeting module for selecting, from the plurality of printed media outlets, at least one printed media outlet that satisfies the at least one predetermined marketing parameter included in the pricing information request and transmitting the pricing information associated with said at least one printed media outlet to said client system.

### RELATED APPLICATION

This application claims the benefit of U.S. Provisional Patent Application Serial No. 60/270,624 filed Feb. 23, 2001, entitled ONLINE MEDIA PLANNING SYSTEM, which application is hereby incorporated by reference in its entirety.

### FIELD OF THE INVENTION

The present invention relates generally to an online method and system for generating targeted pricing information for a marketing campaign and, more specifically, to an online method and system which generates an estimate or quote for the delivery of advertising materials in printed publications which satisfy certain marketing parameters input to the system by a client.

### BACKGROUND

The marketer of consumer package goods (CPG) or the like has a finite amount of money in discretionary budget to spend on marketing efforts. The dilemma is to allocate the limited resource, that is to say the marketing budget, so as to maximize the return on the investment in terms of increased sales of the goods. Before selecting a marketing option, such as one of several coupon promotions covering a selected target audience of consumers, the marketer will often want an estimate from the company that will actually run the promotion. In a coupon example, the client-marketer interested in full-run or zoned targeted media (newspaper) promotions may want more than one estimate for different distribution options.

Existing techniques for providing estimates, however, are labor intensive. A sales representative of the coupon service company must compile the details of each estimate and forward the estimate to the client. With the current process, it can take as long as two weeks to provide an estimate to the client, depending on the coupon service company's internal workload and the complexity of the request. Often the client will request several “what-if” estimates for comparison and then picks the promotion program that appears to offer the best return on the promotional dollar. These multiple requests can further extend the processing time required to generate an accurate estimate.

### SUMMARY OF THE INVENTION

The present invention includes a method and system which enables a client to request pricing information for a marketing campaign via an online connection with a marketing system. The client accesses the website of the marketing system, selects the type of marketing campaign for which pricing information is needed and provides marketing parameters which the client desires to target in the marketing campaign. The marketing system includes a database having profiles and pricing information of printed media outlets, such as newspapers, stored thereon. Each media outlet profile indicates which of a plurality of the marketing parameters the media outlet satisfies. General categories of the marketing parameters are geographic parameters, demographic parameters and circulation schedule parameters. The pricing information includes the cost of delivering advertising materials in the media outlets. In one embodiment of the invention, the advertising materials include printed insert pages that are included with the delivery of the media outlet. The insert pages may include advertisements and coupons. In another embodiment, the advertising materials include advertisements and/or coupons printed directly on the pages of the media outlet. Because of the planning and delivery circumstances involved in each embodiment, the pricing information in the first embodiment is an estimate of the delivery cost, while the pricing information in the second embodiment is an precise quote of the delivery cost.

In the case of the first embodiment of the invention, the marketing system determines which of the media outlets satisfies the marketing parameters desired by the client to be targeted by the marketing campaign and transmits a list of the qualifying media outlets, along with the delivery cost estimate for each, to the client, typically in the form of an email. Alternatively, depending on the processing time involved, a web page may be transmitted to the client which includes the estimates. The client is then able to change the originally submitted parameters in order to obtain further estimates.

In the case of the second embodiment, the system generates a spreadsheet of the qualifying media outlets and the quote of the delivery cost for each media outlet. The spreadsheet is transmitted in the form of a web page to the client and the client is able to select some or all of the media outlets on the spreadsheet and then is able to commit to the quote supplied by the marketing system.

The system dramatically reduces the turnaround-time that it takes for the client to receive an estimate. Instead of the two week turn-around with the current process, the web-based system can provide this information ranging anywhere from 10 minutes to 4 hours depending on the combination of the geographic and demographic parameters input by the client.

The system gives the client the flexibility to change estimate parameters (i.e. page counts, page sizes, geographic and demographic variables, etc.) and re-submit the request an unlimited number of times.

According to one aspect of the invention, a system for generating targeted marketing campaign pricing information for a client system includes a marketing system having a computer processor and associated memory, the marketing system being connectable to the client system via a communications network and a database including pricing information for the delivery of advertising materials in a plurality of printed media outlets, each of the plurality of printed media outlets satisfying at least one of a plurality of predetermined marketing parameters. The marketing system receives a targeted pricing information request from the client system over the communications network. The targeted pricing information request includes at least one of the plurality of predetermined marketing parameters. The marketing system further includes a targeting module for selecting, from the plurality of printed media outlets, at least one printed media outlet that satisfies the at least one predetermined marketing parameter included in the pricing information request and transmitting the pricing information associated with the at least one printed media outlet to the client system via the communication system.

The plurality of printed media outlets may include printed publications. The predetermined marketing parameters may include at least one of a geographical parameter, a demographic parameter and a circulation schedule parameter. The printed publications may include newspapers. The advertising materials may include advertisements printed in the printed publications. The advertising materials may include advertisements printed on pages of the newspapers. The advertising materials may include printed advertisement pages inserted into the newspapers prior to the delivery of the newspapers. The pricing information may includes a quote of the cost of including the advertisements on printed pages of each of the newspapers. The pricing information includes an estimate of the cost of including the advertisement pages with the delivery of the newspapers. The database includes a profile associated with each of the printed publications, wherein the profile includes the predetermined marketing parameters satisfied by the associated printed publication. The targeting module, based on the profiles included on the database system, may determine which of the printed publications satisfies the at least one predetermined marketing parameters included in the targeted pricing information request. The plurality of printed media outlets may include direct mail distributors. The plurality of printed media outlets may include manual distributors of printed materials.

According to another aspect of the invention, a system for generating targeted marketing campaign pricing information for a client system includes a marketing system having a computer processor and associated memory, the marketing system being connectable to the client system via a communications network and a database including pricing information for the delivery of advertisements printed on pages of a plurality of printed publications, each of the plurality of printed publications satisfying at least one of a plurality of predetermined marketing parameters. The marketing system receives a targeted pricing information request from the client system over the communications network. The targeted pricing information request includes at least one of the plurality of predetermined marketing parameters. The marketing system further includes a targeting module for selecting, from the plurality of printed publications, at least one printed publication that satisfies the at least one predetermined marketing parameter included in the pricing information request and transmitting the pricing information associated with the at least one printed media outlet to the client system.

According to yet another aspect of the invention, a system for generating targeted marketing campaign pricing information for a client system includes a marketing system having a computer processor and associated memory, the marketing system being connectable to the client system via a communications network and a database including pricing information for the delivery of printed advertisement pages inserted into a plurality of printed publications, each of the plurality of printed publications satisfying at least one of a plurality of predetermined marketing parameters. The marketing system receives a targeted pricing information request from the client system over the communications network. The targeted pricing information request including at least one of the plurality of predetermined marketing parameters. The marketing system further includes a targeting module for selecting, from the plurality of printed publications, at least one printed publication that satisfies the at least one predetermined marketing parameter included in the pricing information request and transmitting the pricing information associated with the at least one printed media outlet to the client system.

According to yet another aspect of the invention, a method of generating targeted pricing information for a marketing campaign includes:

A. receiving a targeted pricing information request, the targeted pricing information request including at least one of a plurality of predetermined marketing parameters;

B. accessing a data store including a list of a plurality of printed media outlets and associated pricing information for the delivery of advertising materials in each printed media outlet, each of the plurality of printed media outlets being identified as satisfying certain predetermined marketing parameters;

C. selecting, from the list of the plurality of printed media outlets, at least one printed media outlet that satisfies all of the at least one predetermined marketing parameter included in the pricing information request; and

D. generating a targeted pricing information list including the selected printed media outlets and their associated pricing information.

Additional objects, advantages and novel features of the invention will be set forth in part in the description which follows, and in part will become apparent to those skilled in the art upon examination of the following and the accompanying drawings or may be learned by practice of the invention.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 is a block diagram of an exemplary system for the inventive on-line marketing media planning system;

FIG. 2 is a functional block diagram of a general-purpose computer system, which may be used to implement one of the user terminal devices in the overall system of FIG. 1;

FIG. 3 is a functional block diagram of a general-purpose computer, which may function as the web server in the overall system of FIG. 1;

FIG. 4 is a flow diagram of the steps involved in obtaining a pricing estimate for a marketing campaign in accordance with the present invention;

FIG. 5 is a flow diagram of the steps involved in obtaining a pricing quote for a marketing campaign in accordance with the present invention;

FIG. 6 is a flow diagram of the steps carried out by the marketing system for generating pricing information for a marketing campaign in accordance with the present invention;

FIG. 7 is a screen printout of a client and promotion selection web page in accordance with the present invention;

FIG. 8 is a screen printout of a promotion creation web page in accordance with the present invention;

FIG. 9 is a screen printout of an insert estimate request input template web page in accordance with the present invention;

FIG. 10 is a screen printout of a geographic variable selection web page in accordance with the present invention;

FIG. 11 is a screen printout of an insert estimate request preview web page in accordance with the present invention;

FIG. 12 is a screen printout of an insert estimate request confirmation web page in accordance with the present invention;

FIG. 13 is a screen printout of a run-of-press quote request input template web page in accordance with the present invention;

FIG. 14 is a screen printout of a run-of-press estimate request preview web page in accordance with the present invention;

FIG. 15 is a screen printout of a run-of-press market selection web page in accordance with the present invention; and

FIG. 16 is a screen printout of a run-of-press estimate confirmation web page in accordance with the present invention.

### DETAILED DESCRIPTION OF THE PRESENTLY PREFERRED EMBODIMENTS

The inventive concepts relate to a web-based online system, which enables clients to obtain estimates of promotions, such as full-run or zoned targeted media (newspaper) coupon programs. In a coupon example, the estimate includes circulation and media costs at a newspaper level, creating an estimate for the planning of their client consumer promotions and marketing campaigns. After the client submits a pricing information request, the results are e-mailed to the client via the system in an HTML format. From one or more such estimates the client can then select a specific promotional service and send an electronic request to sales personnel of the company offering the promotional services.

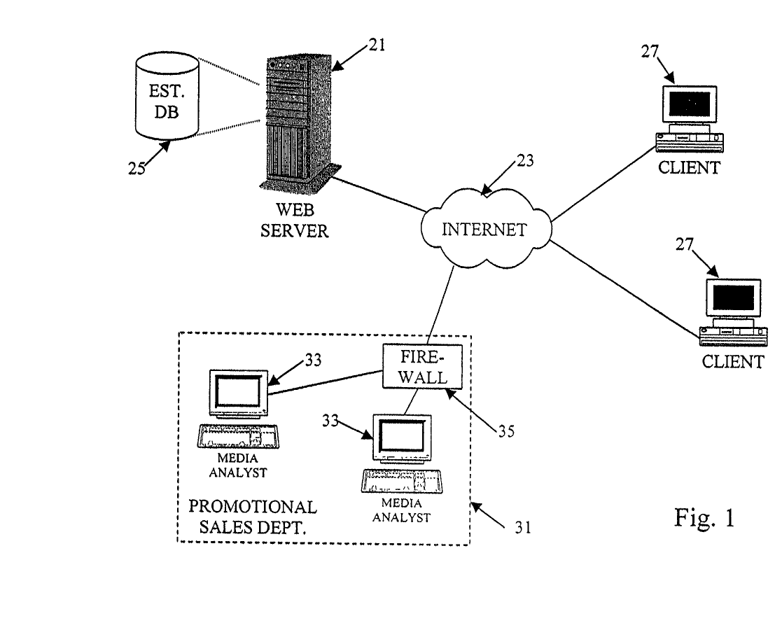

Such an online service can utilize a variety of different physical implementations of the computer and network hardware. To understand the inventive concepts, consider FIG. 1 as a high-level functional diagram of one exemplary implementation.

As shown in FIG. 1, a company offering marketing services, for example as Free Standing Inserts (FSIs) in newspapers and Run-of-Press (ROP) advertising, will operate one or more web servers 21. The server 21 comprises a computer system coupled for connection via a telecommunication network 23. Those skilled in the art will recognize that the computer system of the server 21 may be a single computer at a single location, or the server 21 may actually comprise a number of separately located systems arranged in a distributed processing architecture. The network 23 could be a public telephone network or a private wide area data network, but preferably the network 23 comprises the public data network now commonly referred to as the Internet. The server runs one or more application programs to host web-based information services. The server 21 also maintains a copy of a database 25 of information relating to the marketing campaign services offered by the marketing service company.

Clients who use or are considering use of services of the marketing company will operate one or more client computer systems 27, typically in the form of a personal computer (PC) or workstation. The client computer is a general purpose user terminal with an interface enabling communications with other computers via the Internet 23. Each client computer system 27 runs a number of different applications, for various purposes. One such application is a browser program, allowing the user to access and view web-page information from servers, such as the server 21, via the Internet or other network 23.

In operation, a client operating a client computer system 27 accesses one or more web pages from the server 21. The server 21 implements a log-in procedure, to insure that a user seeking access is an agent of a bonafide client. The marketing agent inputs information about a desired request for an estimate or quote, for example, by point-and-click selections and/or completion of a displayed form. The client computer system 27 sends the information regarding the request for an estimate or quote back to the server 21. Screen shots of several exemplary pages are included and discussed later.

Using the database 25, the server 21 develops pricing information corresponding to the selections input by the client's marketing agent. If completed in real-time, the resulting pricing information could be sent back as a further web-page for display on the client computer system 27. In a currently preferred embodiment, the results are e-mailed to the client computer system 27 via the network 23. Depending on the complexity of the estimate, delivery may take several minutes, or in some cases, several hours. However, this is still much quicker than the two-week turnaround common with existing techniques.

In accord with the invention, at least the generation and delivery of the pricing information is automated. The illustrated systems, however, may also offer options for the client to place an electronic order for a promotional service. The pricing information preferably is in an HTML format. In the automated system, the client electronically orders a selected service, for example by clicking on an embedded URL link, in response to which the client computer system 27 will send an electronic request for the service selected in response to the pricing information from the web server.

The marketing company offering promotional coupon services will operate a marketing system 31, comprising a number of marketing computer systems 33 and other computer and communication elements, such as the firewall 35. The computer systems of the marketing system 31 may be at the same location as the web server 21 and coupled for communication therewith via a local link. Alternatively, as shown in the drawing, the server 21 and the systems of the marketing system 31 may be at different locations and separately coupled to the network 23.

For automated agent services, marketing system 31 will maintain one or more marketing computer systems 33 for its media analysts. Each of the more marketing computer systems 33 comprises a general purpose user terminal, such as a PC or workstation, with an interface enabling communications with other computers via the Internet 23, for example via a firewall 35. Each marketing computer system 33 runs a number of different applications, for various purposes. One such application is an e-mail program, allowing the user-analyst to send and receive e-mail messages, including those from the marketer-clients requesting the promotional services in accord with the invention.

In operation, the client computer systems 27 can send the e-mail requests for actual purchases directly to the analysts at the marketing computer systems 33. Alternatively, the client computer systems 27 could send the service requests to the web server 21, which in turn formulates the requests as e-mails for delivery to the analysts at the marketing computer systems 33. The estimates from the server 21 are generally accurate to ±5%. The analysts operating marketing computer systems 33 would formulate a sales contract with precise actual cost amounts and send that contract back in electronic or paper form, for confirmation and final agreement by the customer.

Aspects of the invention relate to computer systems, typically servers and user terminal devices, programmed to implement the inventive methodology outlined above. To insure a complete understanding of such system-oriented aspects of the invention, it may be helpful to briefly review the structure and general operating principles of such computer systems.

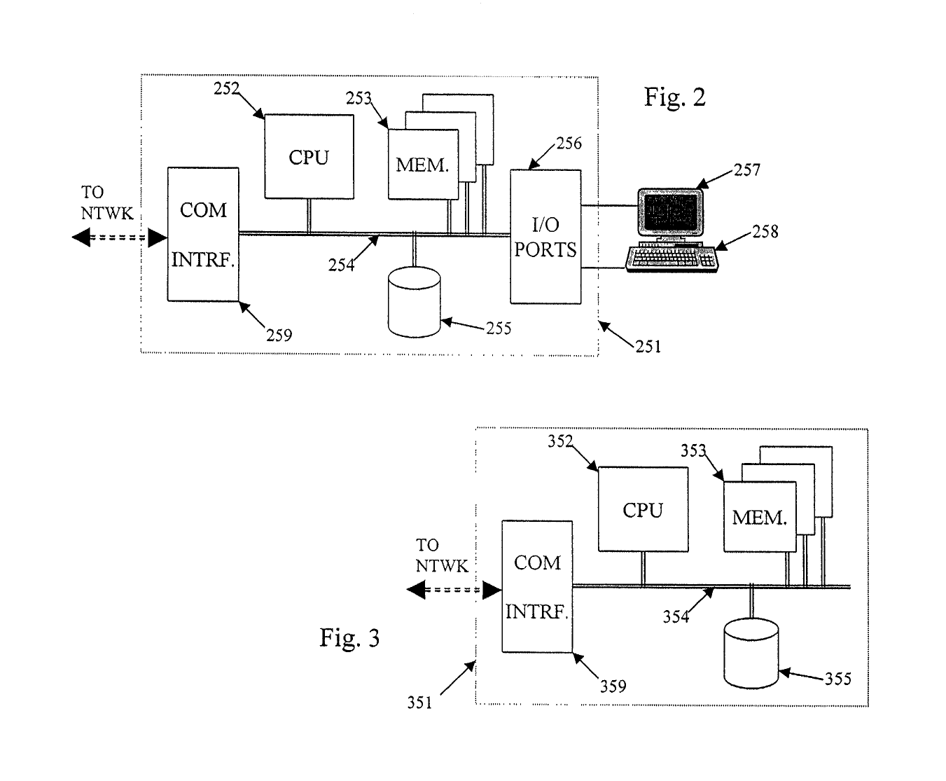

FIG. 2 is a functional block diagram of a PC or workstation type implementation of a system 251, which may serve as one of the user terminals, such as one of the client computer systems 27 or one of the marketing computer systems 33.

The exemplary computer system 251 contains a central processing unit (CPU) 252, memories 253 and an interconnect bus 254. The CPU 252 may contain a single microprocessor, or may contain a plurality of microprocessors for configuring the computer system 252 as a multi-processor system. The memories 253 include a main memory, a read only memory, and mass storage devices such as various disk drives, tape drives, etc. The main memory typically includes dynamic random access memory (DRAM) and high-speed cache memory. In operation, the main memory stores at least portions of instructions and data for execution by the CPU 252.

The mass storage may include one or more magnetic disk or tape drives or optical disk drives, for storing data and instructions for use by CPU 252. For the marketing computer systems 33, at least one mass storage system 255, preferably in the form of a disk drive or tape drive, stores the data tables of an estimation database similar to the database 25. Alternatively, this database may reside on a local server (not shown) within the marketing system 31. The mass storage 255 within the computer system 251 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 251.

The system 251 also includes one or more input/output interfaces for communications, shown by way of example as an interface 259 for data communications via the network 23. The interface 259 may be a modem, an Ethernet card or any other appropriate data communications device. The physical communication links may be optical, wired, or wireless (e.g., via satellite or cellular network).

The computer system 251 may further include appropriate input/output ports 256 for interconnection with a display 257 and a keyboard 258 serving as the respective user interface. For example, the computer may include a graphics subsystem to drive the output display 257. The output display 257 may include a cathode ray tube (CRT) display or liquid crystal display (LCD). Although not shown, the PC type system typically would include a port for connection to a printer. The input control devices for such an implementation of the system 251 would include the keyboard 258 for inputting alphanumeric and other key information. The input control devices for the system may further include a cursor control device (not shown), such as a mouse, a trackball, stylus, or cursor direction keys. The links of the peripherals 257, 258 to the system 251 may be wired connections or use wireless communications.

In the illustrated example, the computer system 251 may be a personal computer or a workstation. Alternatively, the computer system 351 may comprise a mainframe or a server and one or more remote user/operator terminals communicating with the mainframe or server via a network. This alternative implementation may be particularly useful in a large scale implementation of the marketing system 31 or a marketing department of one of the clients.

Each computer system 251 runs a variety of applications programs and stores data, enabling one or more interactions via the user interface, provided through elements such as 257 and 258, and/or over the network 23 to implement the desired processing for the estimation service or the processing of requests for promotional services. The client computer system 27, for example, runs a general purpose browser application and an e-mail program. The media marketing computer systems 33 may run similar general purpose programs. In many cases, however, the marketing computer systems 33 will also run one or more custom programs designed to facilitate generation of precise estimates and attendant sales agreements for the marketing campaigns and the like.

FIG. 3 is a functional block diagram of a general purpose computer system 351, which may perform the functions of the web server 21. The exemplary computer system 351 contains a central processing unit (CPU) 352, memories 353 and an interconnect bus 354. The CPU 352 may contain a single microprocessor, or may contain a plurality of microprocessors for configuring the computer system 352 as a multi-processor system. The memories 353 include a main memory, a read only memory, and mass storage devices such as various disk drives, tape drives, etc. The main memory typically includes dynamic random access memory (DRAM) and high-speed cache memory. In operation, the main memory stores at least portions of instructions and data for execution by the CPU 352.

The mass storage may include one or more magnetic disk or tape drives or optical disk drives, for storing data and instructions for use by CPU 352. At least one mass storage system 355, preferably in the form of a disk drive or tape drive, stores the database 25 used for the generation of estimates in accord with the invention. The mass storage 355 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 351.

The system 351 also includes one or more input/output interfaces for communications, shown by way of example as an interface 359 for data communications via the network 221. The interface 359 may be a modem, an Ethernet card or any other appropriate data communications device. To provide the estimation service to a large number of clients, the interface 359 may need to provide a relatively high-speed link to the network 23. The physical communication link may be optical, wired, or wireless (e.g., via satellite or cellular network). Alternatively, the computer system may comprise a mainframe or other type of host computer system capable of web-based communications via the network 23.

Although not shown, the system 351 may further include appropriate input/output ports for interconnection with a local display and a keyboard or the like serving as a local user interface for programming purposes. Alternatively, the server operations personnel may interact with the system 351 for control and programming of the system from remote terminal devices via the network 23 or some other network link.

The computer system 351 runs a variety of applications programs and stores the database 25. One or more such applications enable the delivery of web pages and the generation of estimates in response to user inputs via the web-based user interface. Those skilled in the art will recognize that the computer system 351 may run other programs and/or host other web-based services. Also, the system 351 may be implemented as a single computer system or as a distributed system having multiple appearances at different nodes on the network 23.

The components contained in the computer systems 251 and 351 are those typically found in general purpose computer systems used as servers, workstations, personal computers, network terminals, and the like. In fact, these components are intended to represent a broad category of such computer components that are well known in the art.

Certain aspects of the invention relate to the software elements, such as the executable code and the database 25 used to implement the estimation functions of the web server 21. The database may be implemented as flat files. Alternatively, the database may take the form of a relational database or even a multi-dimensional database. Components of the inventive software may also reside in the computer systems of the marketing system 31.

At different times all or portions of the executable code or database for any or all of these software elements may reside in physical media or be carried by electromagnetic media. The various data components as well as estimates developed by the inventive processing also may reside in or be transported via a variety of different media. Physical media include the memory of the computer processing systems 251, 351, such as various semiconductor memories, tape drives, disc drives and the like of general-purpose computer systems. All or portions of the software may at times be communicated through the network 23 or various other telecommunication networks. Such communications, for example, may be to load the software from another computer (not shown) into the web server 21 or into another network element. Thus, another type of media that may bear the software elements includes optical, electrical and electromagnetic waves, such as used across physical interfaces between local devices, through wired and optical landline networks and over various air-links.

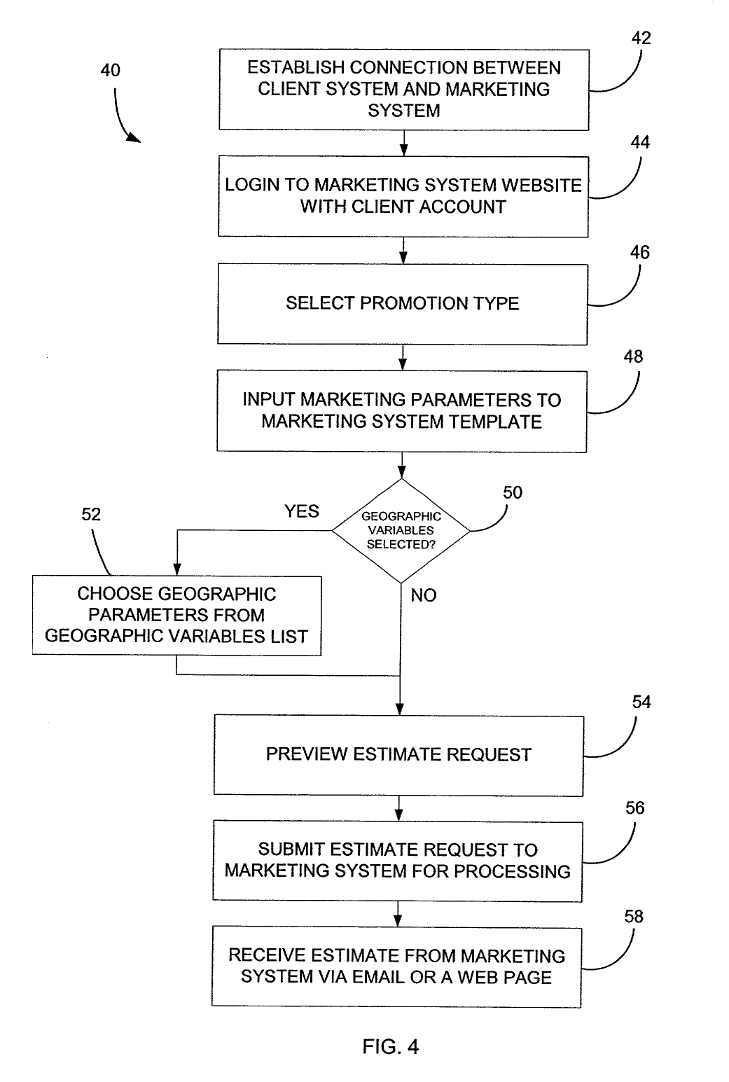

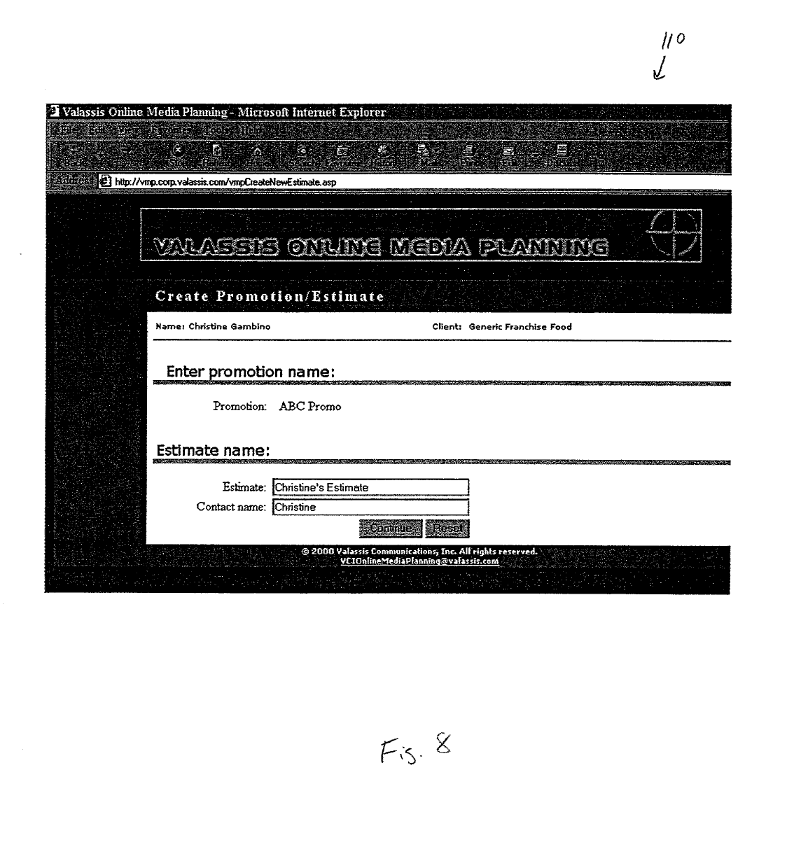

As discussed above, in a first embodiment of the present invention, the marketing system 31 is accessed by the client system 27 in order to obtain an estimate of the cost of including printed insert pages with the delivery of printed media publications, such as newspapers, magazines, etc. FIG. 4 shows a flow diagram 40 which includes the steps involved in obtaining a pricing estimate for a marketing campaign. This process will be described in connection with FIGS. 7-12, which are screen printouts of relevant pages from the website hosted by the marketing system 31 through web server 21.

In step 42 the user of the client computer system 27 establishes a connection with the marketing system 31 and web server 21 via the network 23. This connection is typically established when the client system 27 accesses the website of the marketing system 31 in its browser. After the client system 27 logs into its account with the marketing system 31 with a username and password, or other security protocol, step 44, the client system 27 is presented with the web page 100 shown in FIG. 7. This page enables the client to select the industry of goods or services for which the marketing campaign or promotion estimate is desired in window 102, step 46. A non-exhaustive example of industries that can be selected from box 102 is shown below:

Industry
Telecommunication
Franchise Food
Retail
Insurance
Car Care
Computer Hardware
Financial Services
Packaged Goods
Pharmaceutical

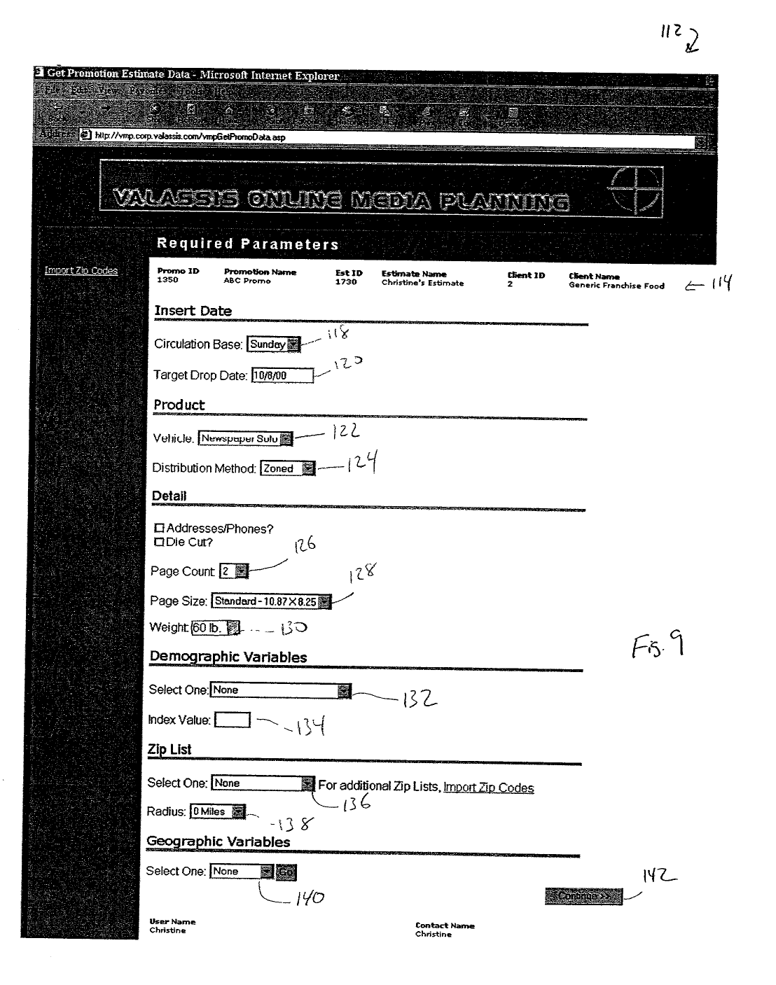

Since most media outlets have different pricing schedules for different industries, this step enables the marketing system to select the proper pricing schedule for the industry selected by the client. Once the industry is selected, the client is able to select whether a new promotion is to be created by selecting “New Promotion” from window 104. If the client has requested estimates for promotions previously, the names of these promotions are included in window 104 to enable the client to select these promotions to request modified estimates. Since each promotion can have more than one estimate, based on differing geographic or demographic parameters, the client must select whether a new estimate is desired by selecting “New Estimate” in window 106, or by selecting a previously generated estimate, which also will be listed in window 106, to modify that estimate. After selecting the industry, promotion and estimate, the client proceeds to the next step in the process by clicking on the “Continue” button 108. The client is then presented with a web page 110, FIG. 8, in which the client is able to enter a name for the promotion, if a request for a new promotion is being submitted, and a name for the particular estimate, as well as the name of the client contact who is requesting the estimate. This step insures that numerous promotions and estimates can be tracked through the system, so as to enable the client system to modify previously created promotions, rather than having to create new promotions for each estimate request. The names of each promotion and estimate are saved in the client's account with the marketing system 31.

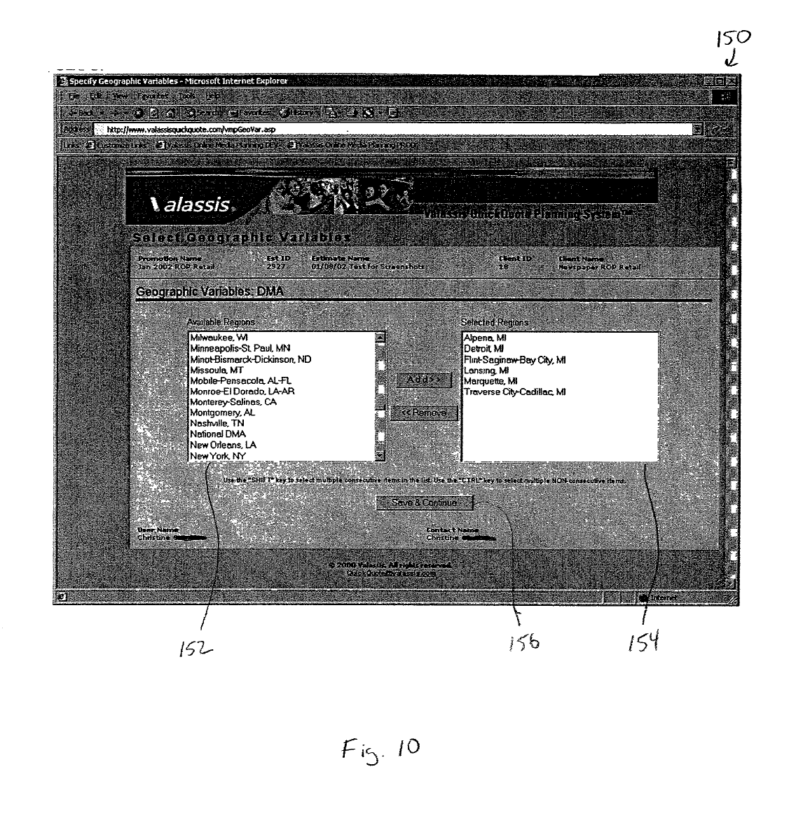

Once the promotion and estimate have been named, required parameters web page 112, FIG. 9 is transmitted to the client system 27. As shown in the figure the required parameters web page 112 is a template which includes the options available to the client for indicating the specific parameters desired for the promotion or marketing campaign. In step 48, FIG. 4, the client inputs the required parameters to the template of web page 112. As shown in FIG. 9, the top portion 114 of the template includes the identifying information of the promotion that was input by the client in step 46. The first parameter to be selected is the date and the edition of the publication in which the promotion will run. The client selects whether the promotion will run in the Sunday edition or daily edition of the publication in window 118 and the date on which the promotion will run in window 120. The next parameter to be selected is the type of publication that the client desires the carry the promotion. In window 122, the client selects the vehicle, which may be a newspaper, magazine, or any printed periodical. In window 124, the client selects whether the promotion will be a “full-run” promotion, in which all editions of the selected vehicle run the promotion or “zoned”, in which only certain editions of the vehicle will run the promotion. In the “Details” portion of the template, the client selects whether the client's (or its customer's) address and/or phone number will be included in the insert and whether the insert pages will be die-cut. In window 126, the client indicates the number of pages that will be included in the insert and, in window 128, the client selects the size of the pages of the insert. The weight of the paper stock can then be selected in window 130.

In window 132, the client is able to select from a list of demographic variables. A non-exhaustive list of demographic variables is shown below:

Demographic Variable

African American
Age 0-13
Age 18+
Age 21+
Age 25-54
Age 45+ w/Household Income (HHI) 50k+
Age 65+
Asian
Female 18+
Female 18-34
Female 25-54
Female 35+
Female 45-64
Female 55+
Female 65+
Females
Female <6
Education College Grad+
HHI 100K+
HHI 15-35K
HHI 25-50K
HHI 35K+
HHI 50K+
HHI 75K+
HHI <15K
HHI <25K
Household Size 1 person
Household Size 2 people
Household Size 3-4 people
Household Size 5+ people
Households w/Kids
Households w/Kids 0-4
Households w/Kids 5-17
Hispanic
Males Age 18+
Males Age 18-34
Males Age 18-54
Males Age 35+
Males Age 35-54
Males Age 45-64
Males Age 55+
Males Age 65+
Males
Males Under 6
Under Age 6
White
Owner Occupied
HS Graduation
Attended College (<4 Yr Degree)
College Degree (4+ Years)
White Collar Occupations
HU built 1985 to Present
Home Value less than $100K
Home Value more than $100K
Home Value more than $250K
Age 25-54 W/HHI 50K+
Age 25-34 W/HHI 25-50K
Age 55+ W/HHI <35K
Age 35-54 W/HHI 50K+

If the client does not desire to include a demographic variable parameter in the estimate request, “None” may be selected in window 132. If the client does select a demographic variable in window 132, a demographic index value must be input to window 134. The demographic index value is calculated by taking the percentage of a particular demographic variable in a zip code or group of zip codes (which are selected in the Zip List portion of the template) and dividing that number by the national average and multiplying the result by 100. For example, assume that the population within zip code 11111 is made up of 63% women and the national average is 50%. The demographic index would be 63 divided by 50 multiplied by 100 ((63/50)*100) which would equal 126. In other words, if the client desires to target area in which more of a particular demographic variable are present, the client would select a demographic index which is greater than 100. If the client desires to target area in which less of a particular demographic variable are present, the client would select a demographic index which is less than 100.

The client is able to select from a list of zip codes in window 136 in order to target particular zip codes. The list of selectable zip codes may be provided by the marketing system 31 or imported by the client system 27. The client also has the option of selecting a distance radius from a selected zip code within which the inserts will be delivered. Finally, the client system is able to select from a variety of predefined geographic variable indexes in window 140. The client can select “None”, if a geographical variable is not desired, or the client may select from several predefined geographical area indexes. These include the following:

MSA—Metropolitan Statistical Area. These are geographical areas with a significant population nucleus, along with any adjacent communities that have a high degree of economic and social integration with that nucleus. They are defined by the U.S. Census Bureau. There are 310 MSAs which encompass approximately 80% of all U.S. households. Not every zip code belongs to a MSA.

DMA—Designated Market Area. These are non-overlapping areas, each consisting of a group of counties. They're useful when planning, buying, and evaluating media buys. All U.S. Counties fall into one of 211 DMAs. Every Zip Code belongs to a DMA.

InfoScan—IRI Infoscan® Information Resources, Inc.'s InfoScan® Tracking Service includes 64 market areas originally defined based upon retailer input, each compassing a central city plus surrounding counties. Product sales, price, distribution, coupon, feature and display activity are tracked in all of the markets. (Source: Trade Dimensions—Market Scope© 2001).

ScanTrack—AC Neilson SCANTRACK® areas covers a designated number of counties. The average number of counties in an AC Nielson SCANTRACK® market is 30, with the range being 1 to 68. In general, market definitions are created by considering retailer warehousing patterns, manufacturer sales districts and television market coverage. All markets include central city, suburban and rural areas. Household purchase data is available from 21 AC Neilson SCANTRACK® markets. (Source: Trade Dimensions—Market Scope© 2001).

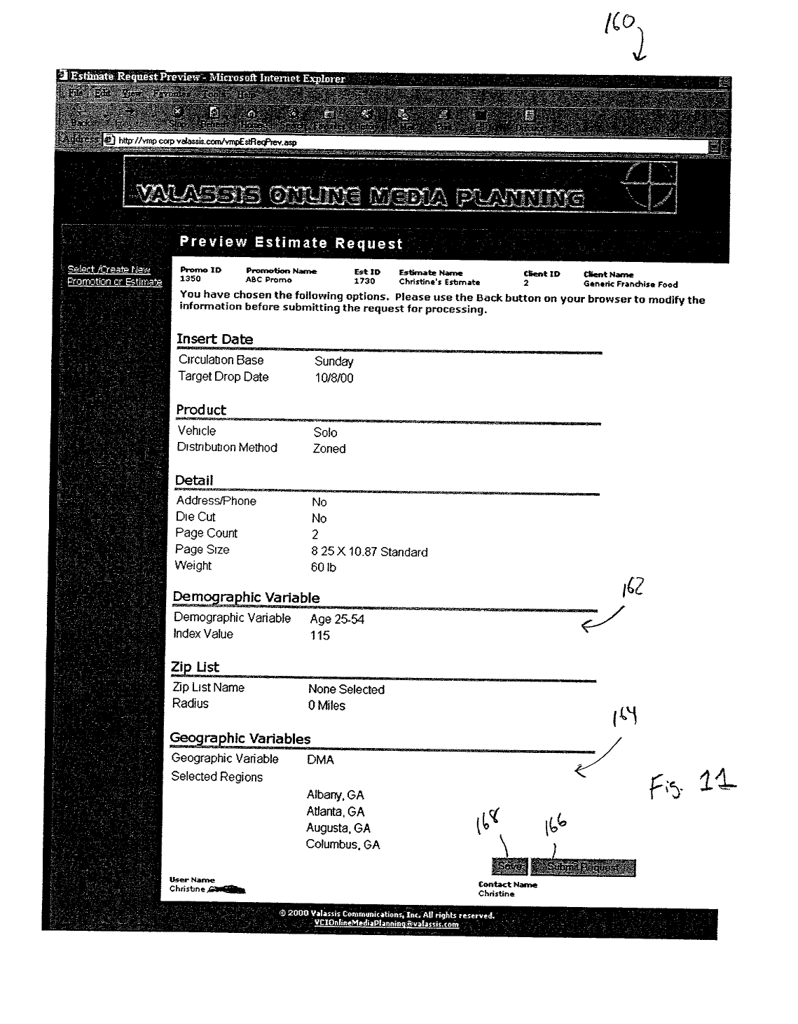

If the client has selected a predefined geographic variable index in box 140, step 50, the client is presented with web page 150, FIG. 10 where specific geographic locations within the geographic variable are selected. In the example shown in FIG. 10, the client has selected the “DMA” index. Window 152 includes a list of all of the Designated Market Areas and the client then selects the desired regions from this list. The selected regions are shown in window 154.

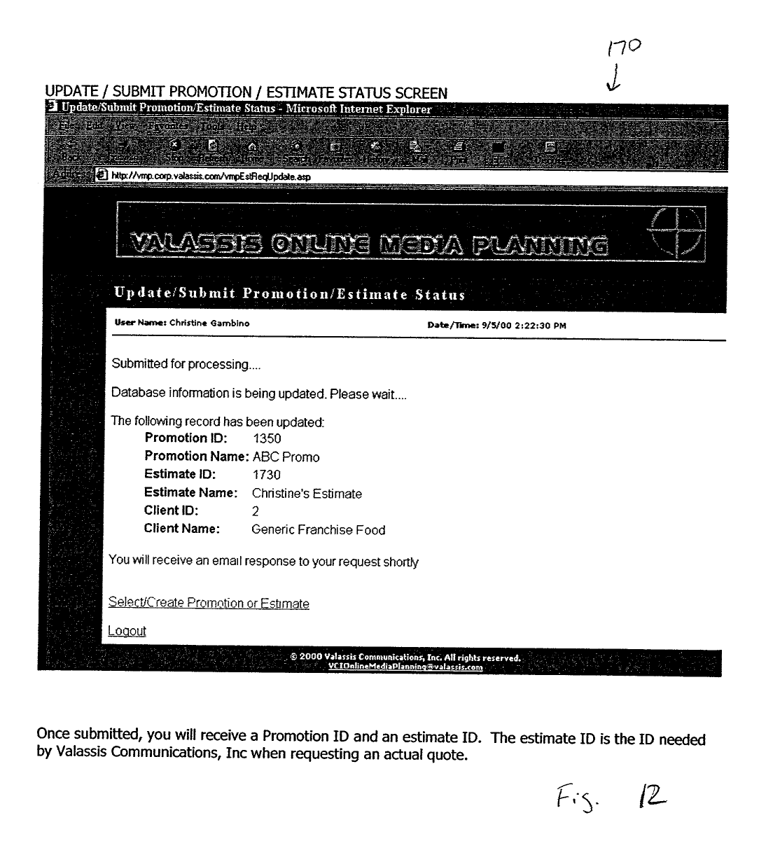

If no predefined geographic variables have been selected, step 50, or the client has completed the geographic parameters selection, step 52, and clicks the “Save & Continue” button 156, the client is presented with an estimate request preview page 160, FIG. 11. This page enables the client to preview the estimate request, including the marketing parameters selected by the client, step 54. If any changes need to be made, the client is instructed to use its “Back” button to return to page 112, FIG. 9, to make the changes. As is shown on page 160, in this example, the client has selected, in the “Demographic Variable” portion 162, an age range of 25-54 with an Index Value of 115. This means that the client wants the promotion to be targeted to an audience in which the printed publication delivering the promotion is 15% more likely to reach the 25-54 age group than in the standard population. As shown at portion 164 of page 160, since, in this example, the client selected “DMA” from the geographic variables window 140, FIG. 9, each of the DMA regions selected by the client from page 150, FIG. 10, are included in the estimate request. When the client is satisfied with the estimate request, the client has the option of submitting the request by clicking “Submit Request” button 166, step 56, or of saving the request for submission at a later time by clicking “Save” button 168. Once the estimate request is submitted, a status page 170 is transmitted to the client system 27 by the marketing system 31, which confirms that the estimate request has been submitted and informs the client that the estimate will be emailed to the client after processing of the request, step 58. Alternatively, the estimate may be transmitted directly to the client system 27 in the form of a web page.

When the marketing system receives the estimate request, it processes the request to locate the printed publications that satisfy the marketing parameters selected by the client. Database 25 includes profiles of printed publications including all of the marketing parameters that each publication satisfies. Along with each probable combination of marketing parameters satisfied by a publication is an estimate or, in the case of the ROP embodiment described below, a quote, for the delivery of the promotion to the desired audience. Because the pricing for each possible combination of marketing parameters is precalculated, the marketing system is able to provide the estimates and quotes to the client systems in a very quick manner.

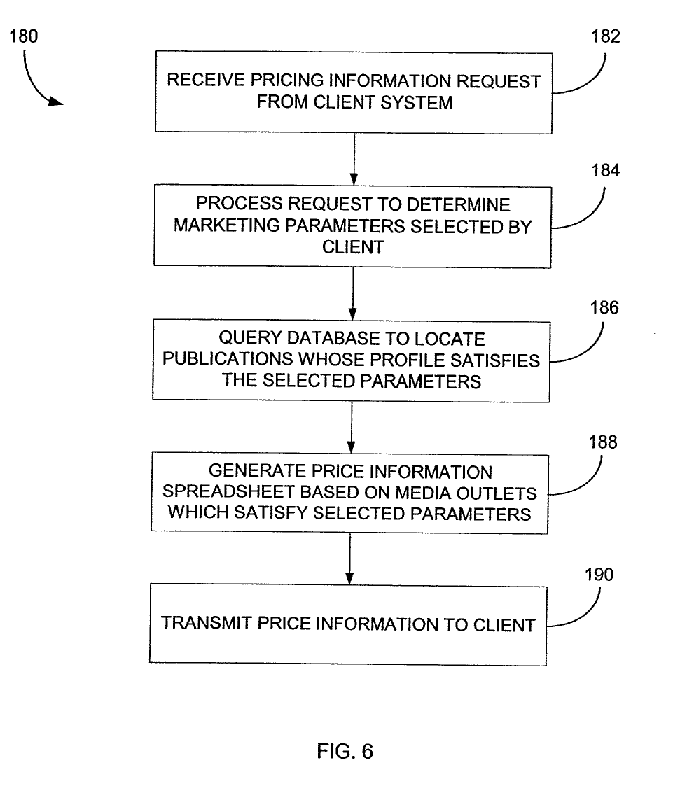

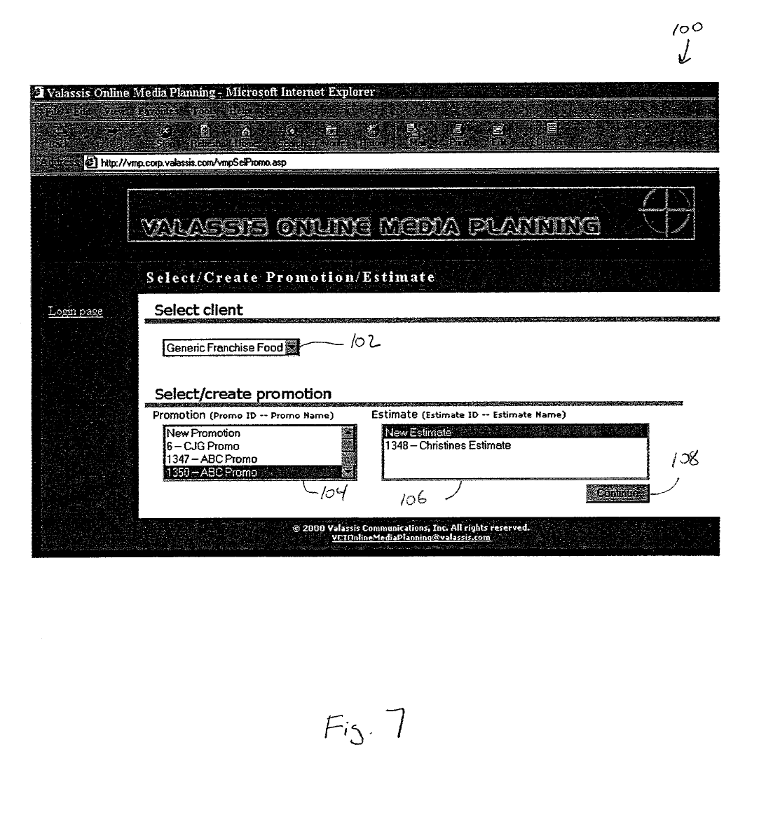

FIG. 6 is a flow diagram 180 which shows the steps involved in the processing of an estimate request. First, as described above, the marketing system receives the request from the client system 27 after the client system completes and submits the request, step 182. The marketing system 31 includes a targeting module which processes the request to identify the marketing parameters selected by the client system, step 184. Once the combination of marketing parameters selected by the client system has been determined, the targeting module of the marketing system 31 queries the database 25 to locate the publications having profiles that indicate that they satisfy the combination of marketing parameters selected by the client system, step 186. Since, as described above, the costs involved in the delivery of promotions to every combination of marketing parameters is precalculated, once the marketing system determines which publications satisfy the selected marketing parameters, a spreadsheet or list that includes the publication and costs is generated, step 188. This list is then transmitted to the client system in the form of an email or web page, as described above, step 190. In the preferred embodiment the targeting module is implemented as an executable software routine, however, it will be understood that the targeting module may be implemented in software, hardware, firmware or any combination of these.

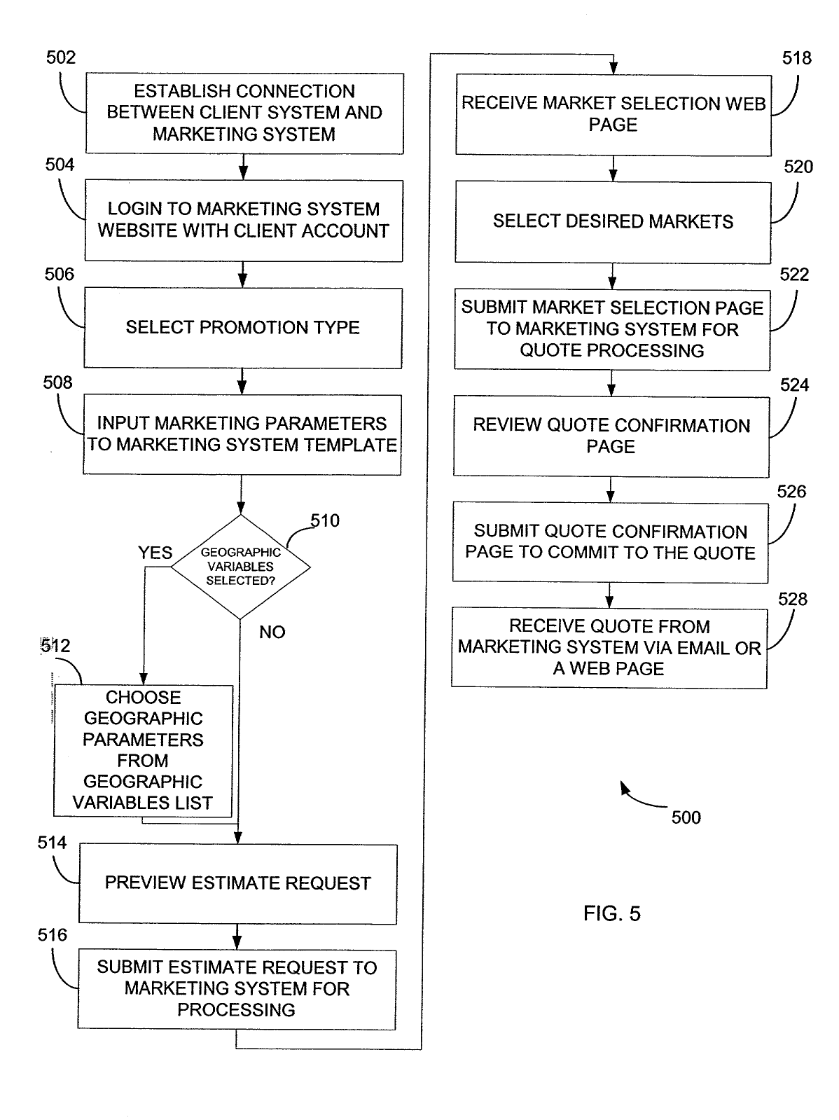

As discussed above, in a second embodiment of the present invention, the marketing system 33 is accessed by the client system 27 in order to obtain a precise quote of the cost of printing promotions on the pages of publications such as newspapers, magazines, etc., the so-called Run-of-Press (“ROP”) promotion. FIG. 5 shows a flow diagram 500 which includes the steps involved in obtaining a pricing quote for a ROP marketing campaign. This process will be described in connection with FIGS. 7, 8, 10 and 13-16, which are screen printouts of relevant pages from the website hosted by the marketing system 31 through web server 21.

In step 502 the user of the client computer system 27 establishes a connection with the marketing system 31 and web server 21 via the network 23. This connection is typically established when the client system 27 accesses the website of the marketing system 31 in its browser. After the client system 27 logs into its account with the marketing system 31 with a username and password, or other security protocol, step 504, the client system 27 is presented with the web page 100 shown in FIG. 7. This page enables the client to select the industry of goods or services for which the marketing campaign or promotion estimate is desired in window 102, step 506. The non-exhaustive example of industries that can be selected from box 102 is shown above in the description of the first embodiment of the invention.

Since most media outlets have different pricing schedules for different industries, this step enables the marketing system to select the proper pricing schedule for the industry selected by the client. Once the industry is selected, the client is able to select whether a new promotion is to be created by selecting “New Promotion” from window 104, FIG. 7. If the client has requested estimates for promotions previously, the names of these promotions are included in window 104 to enable the client to select these promotions to request modified estimates. Since each promotion can have more than one estimate, based on differing geographic or demographic parameters, the client must select whether a new estimate is desired by selecting “New Estimate” in window 106, or by selecting a previously generated estimate, which also will be listed in window 106, to modify that estimate. After selecting the industry, promotion and estimate, the client proceeds to the next step in the process by clicking on the “Continue” button 108. The client is then presented with a web page 110, FIG. 8, in which the client is able to enter a name for the promotion, if a request for a new promotion is being submitted, and a name for the particular estimate, as well as the name of the client contact who is requesting the estimate. This step insures that numerous promotions and estimates can be tracked through the system, so as to enable the client system to modify previously created promotions, rather than having to create new promotions for each estimate request. The names of each promotion and estimate are saved in the client's account with the marketing system 31.

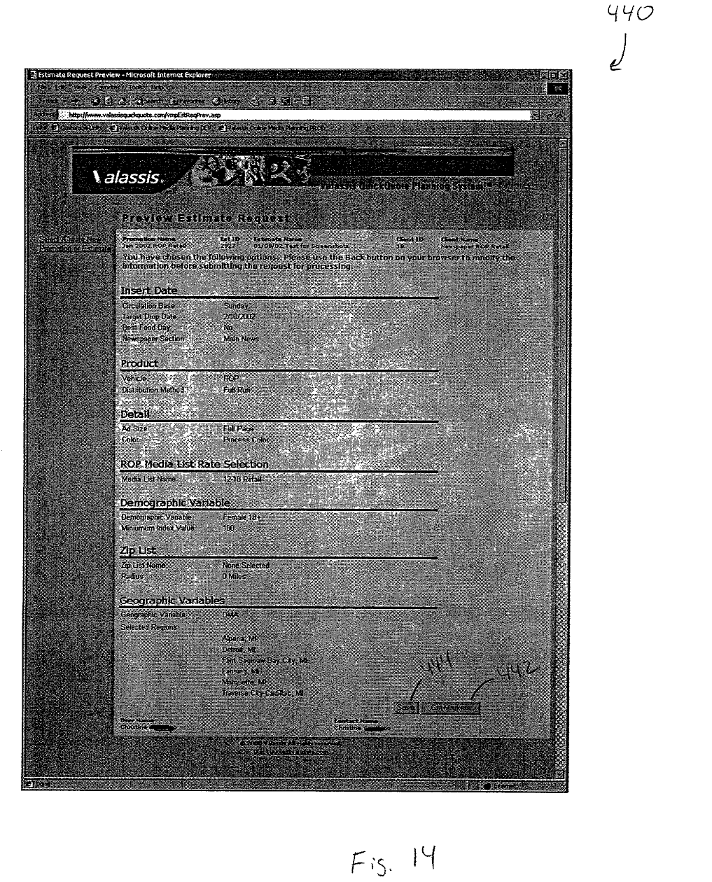

Once the promotion and estimate have been named, a required parameters web page 400, FIG. 13, is transmitted to the client. As shown in the figure, the required parameters web page 400 is a template similar to page 112, FIG. 9, which includes the options available to the client for indicating the specific parameters desired for the ROP promotion or marketing campaign. In step 508, FIG. 5, the client inputs the required parameters to the template of web page 400. As shown in FIG. 13, the top portion 402 of the template includes the identifying information of the promotion that was input by the client in step 506. The first parameter to be selected is the date, the edition of the publication in which the promotion will run, whether the promotion is to run on the day that the publication includes a “Food” section and in which section of the publication the promotion is to be run. The client selects whether the promotion will run in the Sunday edition or daily edition of the publication in window 406 and the date on which the promotion will run in window 408. The section parameter is chosen in window 410. The next parameter to be selected is the type of publication that the client desires the carry the promotion. In window 412, the client selects the vehicle, which may be a newspaper, magazine, or any printed periodical. In window 414, the client selects whether the promotion will be a “full-run” promotion, in which all editions of the selected vehicle run the promotion or “zoned”, in which only certain editions of the vehicle will run the promotion. In the “Detail” portion of the template, the client selects the size, proportional to the page, of the promotion or advertisement that will be printed in window 416 and the color of the advertisement in window 418. Typically, color choices include black-and-white, 1 color, 2 color and process or full color. In window 420, the ROP media list rate is selected. The options available in the media list rate window 420 depend on the industry selected in step 506. In general, clients in a particular industry can construct a media list of pre-selected publications in which they repetitively run their promotions. When a client logs in to the system and chooses an industry in step 506, the system constructs required parameters web page 400 to include, in window 420, any media lists that the have been previously constructed by clients in that industry. The resulting pricing information generated by the system will be based on the selection of publications included in the selected list. The generated pricing information may be based solely on the publications in the list, in which case the client would not select from the demographic and geographic variables described below, or the client can also select from the demographic and/or geographic variables to fine tune the selection of publications within the selected media list.

In window 422, the client is able to select from a list of demographic variables such as the non-exhaustive list of demographic variables shown above. If the client does not desire to include a demographic variable parameter in the estimate request, “None” may be selected in window 422. If the client does select a demographic variable in window 422, a demographic index value must be input to window 424.

The client is able to select from a list of zip codes in window 436 in order to target particular zip codes. The list of selectable zip codes may be provided by the marketing system 31 or imported by the client system 27. The client also has the option of selecting a distance radius from a selected zip code within which the inserts will be delivered. Finally, the client system is able to select from a variety of predefined geographic variables in window 430. The selectable geographic variables are typically the same as those described above with reference to FIG. 9. The client can select “None”, if a geographical variable is not desired, or the client may select from several predefined geographical area indexes.

If the client has selected a predefined geographic variable in box 140, step 510, the client is presented with web page 150, FIG. 10 where specific geographic locations within the geographic variable are selected. A description of page 150 is set forth above.

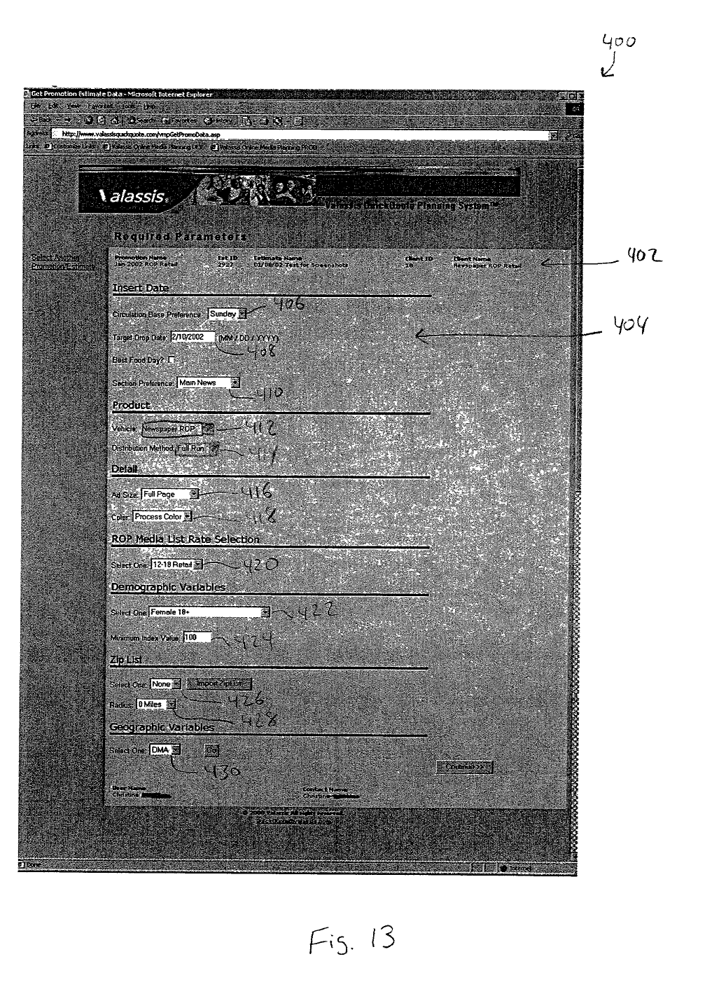

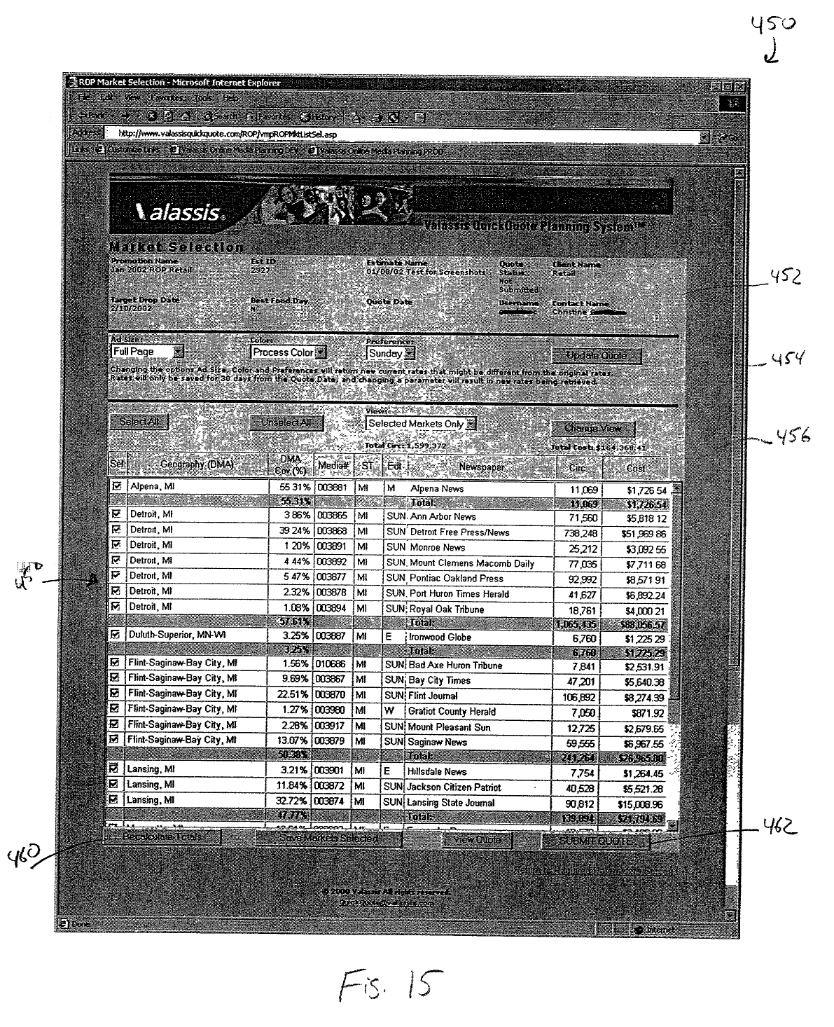

If no predefined geographic variables have been selected, step 510, or the client has completed the geographic parameters selection, step 512, and clicks the “Save & Continue” button 156, the client is presented with an estimate request preview page 440, FIG. 14. This page enables the client to preview the quote request, including the marketing parameters selected by the client, step 514. If any changes need to be made, the client is instructed to use its “Back” button to return to page 400, FIG. 12, to make the changes. When the client is satisfied with the estimate request, the client has the option of submitting the request by clicking “Get Markets” button 442, step 516, or of saving the request for submission at a later time by clicking “Save” button 444. Once the estimate request is submitted, marketing system 31 processes the request, as described above with reference to FIG. 6, and a market selection page 450 is transmitted to the client system 27 by the marketing system 31, step 518.

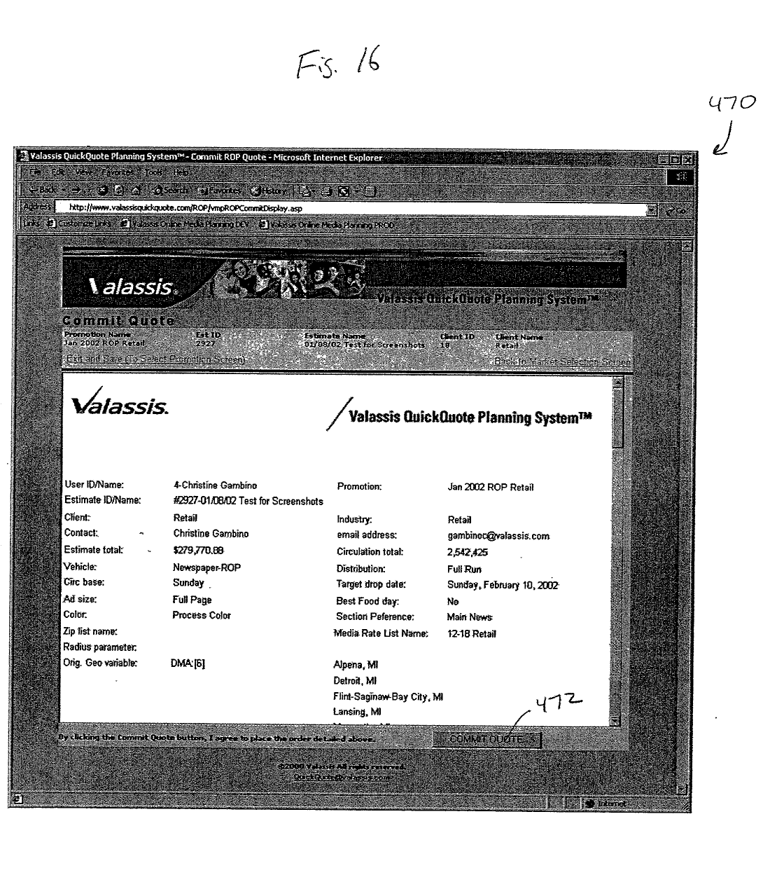

Market selection page 450 enables the client to fine tune the quote request by providing a listing of all of the publications that satisfy the marketing parameters selected by the client system and the cost of the delivery of the promotion in these publications. Market selection page 450 includes a portion 452 which includes identification information of the promotion and an update portion 454 that enables the client to the size and color of the advertisement, as well as the edition in which the advertisement will run. Changing any of these options and clicking the “Update Quote” button causes the marketing system to reprocess the request using the method described with reference to FIG. 6. Market listing portion 456 includes a listing of all of the publications that have been determined by the marketing system 31 to satisfy the parameters selected by the client system 27. As shown in FIG. 15, market listing portion 456 includes the name of each selected publication, as well as the geographic coverage of the publication, the total circulation and the quote for delivering the client's promotion. The client system is able to select (or deselect) each publication that it wants to include in its marketing campaign using selection boxes 458, step 520. If publications are selected or deselected, clicking the “Recalculate Totals” button 460 updates the quote. Once the client has selected the desired publications and is satisfied with the quote, the quote is submitted by clicking the “Submit Quote” button 462, step 522. The marketing system then processes the quote, making the necessary modifications desired by the client and transmits a quote confirmation page 470 to the client system 27. As shown in FIG. 16, quote confirmation page 470 lists all of the details of the quote, including all of the marketing parameters selected by the client system, the total cost of the promotion, the total circulation, the geographical areas covered and, although not shown in this figure, the list of publications in which the promotion will be carried (the list is included in the portion of the page that is not visible in this printout). After reviewing the quote confirmation page 470, step 524, the client system commits to order the promotion that is the subject of the quote by clicking the “Commit Quote” button 472, step 526. Once the client commits to the quote, the client system 27 receives a quote confirmation from the marketing system 31 via an email or web page, step 528.

Accordingly, the present invention enables a client to select a variety of marketing parameters for a marketing campaign and receive an estimate or quote from the marketing system in an automation fashion. This system reduces costs for the client, since less human processing is required on the part of the marketing system, and it provides the estimate or quote to the client in a much quicker time frame than prior art systems.

While the foregoing has described what are considered to be the best mode and/or other preferred embodiments of the invention, it is understood that various modifications may be made therein and that the invention may be implemented in various forms and embodiments, and that it may be applied in numerous applications, only some of which have been described herein. For example, while the invention has been described as applying to printed publications such as newspapers and magazines, it will be understood that the invention is also capable of providing estimates for direct mail campaigns, in which printed promotions are provided to potential customers through direct mailings, and in which case the marketing system 31 would select, from a database of direct mail companies, certain direct mail companies that satisfy the marketing parameters selected by the client system. The invention could also be utilized in the planning of hand-delivered promotions. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. A system for generating targeted marketing campaign pricing information for a client system comprising:
a marketing system including a computer processor and associated memory, said marketing system being connectable to the client system via a communications network; and
a database including pricing information for the delivery of advertising materials in a plurality of printed media outlets, each of said plurality of printed media outlets satisfying at least one of a plurality of predetermined marketing parameters;
wherein said marketing system receives a targeted pricing information request from the client system over said communications network, said targeted pricing information request including at least one of said plurality of predetermined marketing parameters;
said marketing system further including a targeting module for selecting, from said plurality of printed media outlets, at least one printed media outlet that satisfies said at least one predetermined marketing parameter included in said pricing information request and transmitting the pricing information associated with said at least one printed media outlet to the client system via the communication system.

2. The system of claim 1 wherein said plurality of printed media outlets comprise printed publications.

3. The system of claim 2 wherein said predetermined marketing parameters include at least one of a geographical parameter, a demographic parameter and a circulation schedule parameter.

4. The system of claim 3 wherein said printed publications comprise newspapers.

5. The system of claim 3 wherein said advertising materials include advertisements printed in said printed publications.

6. The system of claim 4 wherein said advertising materials include advertisements printed on pages of said newspapers.

7. The system of claim 4 wherein said advertising materials include printed advertisement pages inserted into said newspapers prior to the delivery of said newspapers.

8. The system of claim 6 wherein said pricing information includes a quote of the cost of including said advertisements on printed pages of each of said newspapers.

9. The system of claim 7 wherein said pricing information includes an estimate of the cost of including said advertisement pages with the delivery of said newspapers.

10. The system of claim 2 wherein said database includes a profile associated with each of said printed publications, wherein said profile includes the predetermined marketing parameters satisfied by the associated printed publication.

11. The system of claim 10 wherein said targeting module, based on said profiles included on said database, determines which of said printed publications satisfies said at least one predetermined marketing parameters included in said targeted pricing information request.

12. The system of claim 1 wherein said plurality of printed media outlets comprise direct mail distributors.

13. The system of claim 1 wherein said plurality of printed media outlets comprise manual distributors of printed materials.

14. A system for generating targeted marketing campaign pricing information for a client system comprising:
a marketing system including a computer processor and associated memory, said marketing system being connectable to the client system via a communications network; and
a database including pricing information for the delivery of advertisements printed on pages of a plurality of printed publications, each of said plurality of printed publications satisfying at least one of a plurality of predetermined marketing parameters;
wherein said marketing system receives a targeted pricing information request from the client system over said communications network, said targeted pricing information request including at least one of said plurality of predetermined marketing parameters;
said marketing system further including a targeting module for selecting, from said plurality of printed publications, at least one printed publication that satisfies said at least one predetermined marketing parameter included in said pricing information request and transmitting the pricing information associated with said at least one printed media outlet to the client system.

15 The system of claim 14 wherein said plurality of printed publications comprise newspapers.

16. The system of claim 14 wherein said predetermined marketing parameters include at least one of a geographical parameter, a demographic parameter and a circulation schedule parameter.

17. The system of claim 15 wherein said predetermined marketing parameters include at least one of a geographical parameter, a demographic parameter and a circulation schedule parameter.

18. The system of claim 17 wherein said pricing information includes a quote of the cost of including said advertisements on printed pages of each of said newspapers.

19. The system of claim 14 wherein said database system includes a profile associated with each of said printed publications, wherein said profile includes the predetermined marketing parameters satisfied by the associated printed publication.

20. The system of claim 19 wherein said targeting module, based on said profiles included on said database, determines which of said printed publications satisfies said at least one predetermined marketing parameters included in said targeted pricing information request.

21. A system for generating targeted marketing campaign pricing information for a client system comprising:
a marketing system including a computer processor and associated memory, said marketing system being connectable to the client system via a communications network; and
a database including pricing information for the delivery of printed advertisement pages inserted into a plurality of printed publications, each of said plurality of printed publications satisfying at least one of a plurality of predetermined marketing parameters;
wherein said marketing system receives a targeted pricing information request from the client system over said communications network, said targeted pricing information request including at least one of said plurality of predetermined marketing parameters;
said marketing system further including a targeting module for selecting, from said plurality of printed publications, at least one printed publication that satisfies said at least one predetermined marketing parameter included in said pricing information request and transmitting the pricing information associated with said at least one printed media outlet to the client system.

22. The system of claim 21 wherein said plurality of printed publications comprise newspapers.

23. The system of claim 22 wherein said pricing information includes an estimate of the cost of including said advertisement pages with the delivery of said newspapers.

24. The system of claim 21 wherein said database includes a profile associated with each of said printed publications, wherein said profile includes the predetermined marketing parameters satisfied by the associated printed publication.

25. The system of claim 24 wherein said targeting module, based on said profiles included on said database system, determines which of said printed publications satisfies said at least one predetermined marketing parameters included in said targeted pricing information request.

26. A method of generating targeted pricing information for a marketing campaign comprising:
A. receiving a targeted pricing information request, said targeted pricing information request including at least one of a plurality of predetermined marketing parameters;
B. accessing a data store including a list of a plurality of printed media outlets and associated pricing information for the delivery of advertising materials in each printed media outlet, each of said plurality of printed media outlets being identified as satisfying certain predetermined marketing parameters;
C. selecting, from said list of said plurality of printed media outlets, at least one printed media outlet that satisfies all of said at least one predetermined marketing parameter included in said pricing information request; and
D. generating a targeted pricing information list including said selected printed media outlets and their associated pricing information.
